(19) United States
(12) Patent Application Publication
(10) Pub. No.: US 2022/0172249 A1
(43) Pub. Date: Jun. 2, 2022

(54) Systems and Methods for Providing Targeted Advertising

(71) Applicant: Toyota Motor North America, Inc., Plano, TX (US)

(72) Inventors: Jake Morrow, Carrollton, TX (US); Evan Vijithakumara, Frisco, TX (US); Dany Benjamin, Rowlett, TX (US)

(73) Assignee: Toyota Motor North America, Inc., Plano, TX (US)

(21) Appl. No.: 17/109,881

(22) Filed: Dec. 2, 2020

(51) Int. Cl. G06Q 30/02; G06K 9/00; G06F 3/01; G01C 21/36

(52) U.S. Cl. CPC G06Q 30/0255; G06Q 30/0271; G01C 21/3697; G06K 9/00838; G06F 3/013; G06Q 30/0266

(57) ABSTRACT

An advertising system is provided. The advertising system includes a vehicle, one or more imaging devices, one or more gaze sensors, and an electronic control unit. The imaging devices and the gaze sensors are coupled to the vehicle. An image data contains an advertisement data captured from the environment external to the vehicle. A gaze data contains data as to whether one or more individuals within the vehicle have viewed the advertising medium. The electronic control unit analyzes the image data to determine the advertisement data, determines that at least one individual is engaged with the advertising medium, determines a current route of the vehicle, obtains a calendar of the at least one individual, and provides a targeted ad to the at least one individual based on the current route of the vehicle and an allotted time based on the calendar of the one or more individuals.

### TECHNICAL FIELD

The present specification generally relates to systems and methods for monitoring and analyzing users to provide targeted advertising and, more specifically, to systems and methods that use intelligence regarding individual users to provide relevant advertising.

### BACKGROUND

Advertisements, such as billboards, grand opening signs, sale signs, and the like are intended to provide targeted advertising to consumers to ensure that a consumer is provided with an ad or a version of the ad that is most likely to have an impact on the consumer. Current targeted ad systems may provide personalized advertisements based on browsing history or geographic location of the consumer. However, the known current targeted ad systems do not incorporate gaze-tracking information or other psychographic information regarding the consumer and machine learning to provide personalized advertisements to the customer.

### SUMMARY

In one embodiment, an advertising system is provided. The advertising system includes a vehicle, one or more imaging devices, one or more gaze sensors, and an electronic control unit. The one or more imaging devices are coupled to the vehicle and that obtain an image data. The image data contains an advertisement data captured from an environment exterior of the vehicle. The one or more gaze sensors are coupled to the vehicle and that obtain a gaze data. The gaze data contains data as to whether one or more individuals within the vehicle have viewed the advertisement data. The electronic control unit analyzes the image data to determine the advertisement data, determines that at least one individual of the one or more individuals are engaged with the advertisement data, determines a current route of the vehicle based on a current route data, obtains a calendar of the at least one individual of the one or more individuals, and provides a targeted ad to the at least one individual of the one or more individuals based on the current route of the vehicle and an allotted time based on the calendar of the one or more individuals.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a block diagram of the various components of an illustrative advertising system according to one or more embodiments shown and described herein;

FIG. 2 schematically depicts a block diagram of illustrative computer processing hardware components according to one or more embodiments shown and described herein; and

FIG. 3A schematically depicts a viewing area of an illustrative imaging device capturing an image of a billboard according to one or more embodiments shown and described herein;

FIG. 3B schematically depicts a viewing area of an illustrative imaging device capturing an image of a store front according to one or more embodiments shown and described herein;

FIG. 4A depicts a flow diagram of an illustrative method of displaying targeted advertising to an individual according to one or more embodiments shown and described herein; and

FIG. 4B schematically depicts a flow diagram of an illustrative method of determining a subset of engaged users according to one or more embodiments shown and described herein.

### DETAILED DESCRIPTION

The embodiments described herein are generally directed to systems and methods that capture image advertisement data external to a vehicle, determine whether individuals present in the vehicle are engaged with advertisement data via an eye gaze determination and/or psychographic features to determine whether an individual is an engaged individual, determine corresponding route information for the advertised place and compare the route information with future route requirements and calendar data of the individuals present in the vehicle are engaged with advertisement data, and provide targeted advertising to the individual based on the calendar of the driver, the current vehicle route, a predicted future vehicle route, a modified route, and/or past driver behaviors. As such, a plurality of personalized advertisements may be presented to individuals present in the vehicle.

As used herein, an “advertisement data”, “advertisement” and/or “advertising” generally refer to any type of advertisement positioned in an environment external to the vehicle. For example, an advertisement data may be data relating to a billboard that is static or dynamically changing ads at some predetermined period of time. In another example, advertisement data may be any signage positioned at a business such as a sale sign, a poster, a grand opening sign, a name of the business, a pictorial or graphic, and the like. As such, advertisement data includes words, numbers, pictures, graphics, and the like, gathered from objects that are intended for a plurality of individuals have an opportunity to view the message being conveyed. Further, advertisement data may refer to a single advertising location or a plurality of locations (e.g., the same type of advertisement provided at a plurality of different advertising locations). Additionally, advertising data may refer to how busy a particular establishment is at a specific time such as how busy a coffee shop is determined by the number of vehicles or people in line as the vehicle drives by the particular establishment.

As used herein, the term “communicatively coupled” means that coupled components are capable of exchanging data signals and/or electric signals with one another such as, for example, electronic signals via conductive medium, electromagnetic signals via air, optical signals via optical waveguides electronic energy via conductive medium or a non-conductive medium, data signals wirelessly and/or via conductive medium or a non-conductive medium and the like.

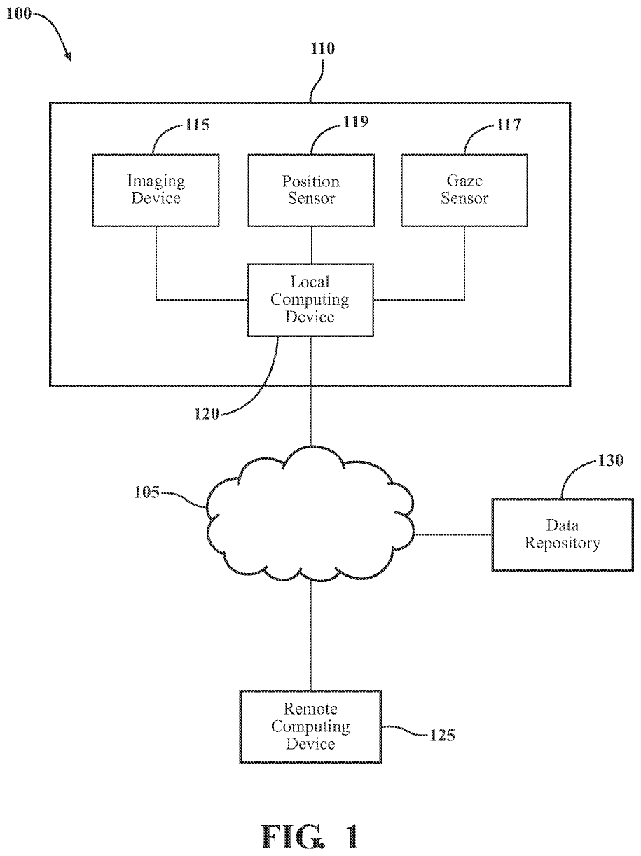

Referring now to the figures, FIG. 1 depicts a block diagram of the various components of an advertising system 100. The advertising system 100 may generally include a computer network 105, a vehicle 110, a remote computing device 125 and a data repository 130.

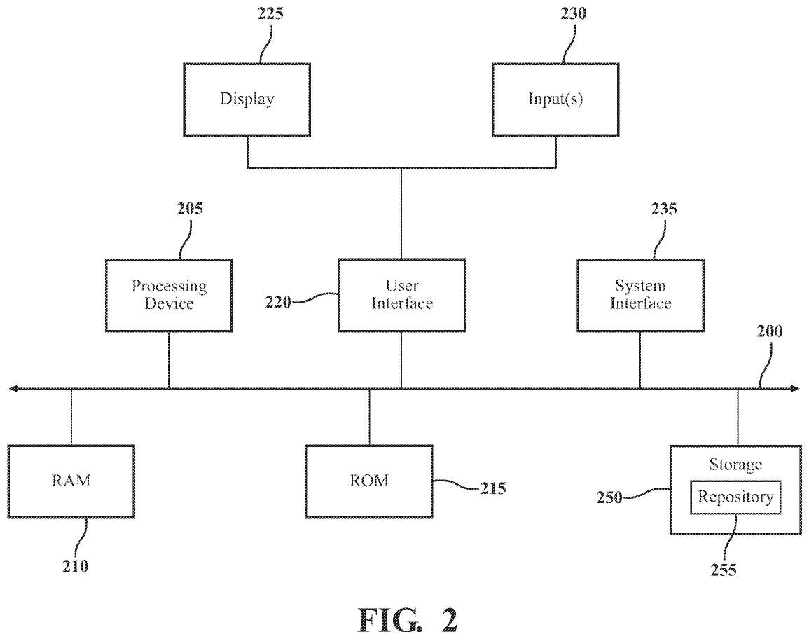

The vehicle 110 may generally be any vehicle with one or more onboard computing devices, such as an electronic control unit 120, one or more imaging devices, such as an imaging device 115 and one or more gaze sensors, such as a gaze sensor 117. The one or more onboard computing devices contain hardware for processing data, storing data, displaying data, and detecting objects such as other vehicles, storefronts, and/or advertising outside of the vehicle 110. Thus, the vehicle 110 and/or components thereof may perform one or more computing functions, such as receiving data from a vehicle occupant or devices thereof (i.e., the remote computing device 125), storing the data, determining whether individuals present in the vehicle are engaged with advertisement data via an eye gaze determination (i.e., gaze data) and/or psychographic features, determine corresponding route information for the advertised place and compare the route information with future route requirements and calendar and/or appointment data (i.e., allotted time) of the individuals present in the vehicle that are engaged with advertisement data so to provide targeted advertising to the individual based on the calendar or appointment schedule of the individual, the current vehicle route, a predicted future vehicle route, a modified route and/or past individual behaviors. Past individual behaviors may include past histories of stopping at establishments along a given current route, a modified current route, and/or a predicted future route. Further, the vehicle 110 and/or components thereof may perform one or more computing functions, such as controlling a display device 225 (FIG. 2) to display targeted advertising information to the occupants of the vehicle, as described in greater detail herein.

As illustrated in FIG. 1, the computer network 105 may include a wide area network (WAN), such as the Internet, an intranet, a local area network (LAN), a mobile communications network, a public service telephone network (PSTN), a personal area network (PAN), a metropolitan area network (MAN), a virtual private network (VPN), and/or another network. The computer network 105 may be configured to communicatively connect one or more computing devices and/or components thereof. Illustrative computing devices may include, but are not limited to, an electronic control unit 120 and a remote computing device 125. In some embodiments, the computer network 105 may also connect a data repository 130.

The electronic control unit 120 refers generally to a computing device that is positioned within a vehicle 110. As such, the electronic control unit 120 is local in the sense that it is local to the vehicle 110. In various embodiments, the electronic control unit 120 may be communicatively coupled to the image capturing device 115, the gaze sensor 117 and/or the position sensor 119 via any wired or wireless connection now known or later developed. Thus, the electronic control unit 120 may be communicatively coupled to the image capturing device 115 via one or more wires, cables, and/or the like, or may be coupled via a secure wireless connection using one or more wireless radios, such as, for example, Bluetooth, an 802.11 standard, near field communication (NFC), and/or the like. In some embodiments, the electronic control unit 120 may be communicatively coupled to the image capturing device 115, the gaze sensor 117 and/or the position sensor 119 via a wired connection to avoid interception of signals and/or data transmitted between the image capturing device 115, the gaze sensor 117 and/or the position sensor 119 and the electronic control unit 120. As also described in greater detail herein, the image capturing device 115 and the electronic control unit 120 may be communicatively coupled such that data, such as image data or the like, may be transmitted between the image capturing device 115 and the electronic control unit 120. Further, the gaze sensor 117 and the electronic control unit 120 may be communicatively coupled such that data, such as image data, eye gaze data, and/or the like, may be transmitted between the gaze sensor 117 and the electronic control unit 120, as discussed in greater detail herein. Additionally, the position sensor 119 and the electronic control unit 120 may be communicatively coupled such that data, such as position of vehicle data, location of the advertised store data, and/or the like, may be transmitted between the position sensor 119 and the electronic control unit 120, as discussed in greater detail herein.

In some embodiments, the image capturing device 115, the gaze sensor 117 and/or the position sensor 119 may be integrated with the electronic control unit 120 (e.g., a component of the electronic control unit 120). In other embodiments, the image capturing device 115, the gaze sensor 117 and/or the position sensor 119 may be a standalone device that is separate from the electronic control unit 120. In some embodiments, the image capturing device 115, the gaze sensor 117 and/or the position sensor 119 and the electronic control unit 120 may be combined into a single unit that is integrated within the vehicle 110.

The image capturing device 115 is not limited by this disclosure, and may generally be any device that captures images. That is, any suitable commercially available image capturing device 115 may be used without departing from the scope of the present disclosure. In some embodiments, the image capturing device 115 may be a camera, camcorder, or the like, and may incorporate one or more image sensors, one or more image processors, one or more optical elements, and/or the like. In some embodiments, the image capturing device 115 may be capable of focusing on a target object, zooming in and out, and/or moving, such as, for example, panning, tilting, and/or the like. In some embodiments, the image capturing device 115 may be capable of tracking a moving object, such as, for example, a vehicle moving at a storefront, and/or the like. As such, the image capturing device 115 may incorporate various motion sensing and/or tracking components, software, and/or the like that are generally understood as providing tracking capabilities. In some embodiments, movement of the imaging device 115 may be remotely controlled by a user.

While FIG. 1 depicts a single image capturing device 115, it should be understood that any number of image capturing devices may be used without departing from the scope of the present disclosure. For example, the image capturing device 115 may be a plurality of imaging devices arranged to capture an image in tandem, such as, for example, to capture a larger field of view than what would be possible with a single image capturing device 115 or to capture a plurality of different angles of the same field of view. In another example, a plurality of image capturing devices 115 may be used to capture various angles of a particular area at or near the advertisement. In yet another example, a plurality of image capturing devices 115 may be positioned to capture various specific areas within a more general area, such as various drive through lines and parking lots of a restaurant or the like.

In some embodiments, the image capturing device 115 may capture high dynamic range (HDR) images. In some embodiments, the image capturing device 115 may capture a plurality of images successively (e.g., “burst mode” capture), may capture single images at particular intervals, and/or may capture motion images (e.g., video capture). That is, as used herein, the term “images” or “image” refers to video images (i.e., a sequence of consecutive images), still images (including still images isolated from video images), and/or image data. In embodiments where images are captured at particular intervals, illustrative intervals may include, but are not limited to, every second, every 2 seconds, every 3 seconds, every 4 seconds, every minute, every 2 minutes, every 5 minutes, every 30 minutes, every hour, or the like. In addition to capturing images, the image capturing device 115 may record information regarding the image capture, such as, for example, a time stamp of when the image was captured, a frame rate, a field of view, and/or the like. Each captured image and the recorded information may be transmitted as image data to the electronic control unit 120.

The electronic control unit 120 may be configured to receive the image data from the image capturing device 115, process the image data to determine whether the image data contains advertisement data, determine whether individuals present in the vehicle are engaged with advertisement data via an eye gaze determination based on the length of time looking at the advertisement data, multiple looks at the advertisement data, psychographic features, and the like (i.e., gaze data), and display targeted advertising and/or provide information to the occupants of the vehicle based on the current route of the vehicle, a predicted upcoming route and/or a modified current route, each of which correspond to known appointments and calendar events (i.e., an allotted time between appointments and/or calendar events) of the individuals positioned within the vehicle, as discussed in greater detail herein.

That is, a gaze determination may be performed by analyzing the gaze data to determine whether the individual's gaze at the advertising medium exceeds a predetermined amount of time threshold and/or whether the gaze data is analyzed to determine whether the individual's gaze at the advertising medium is a reengagement of the at least one individual by exceeding a predetermined number of times that a gaze of the at least one individual returns to the advertisement medium, as discussed in greater detail herein.

The gaze sensor 117 is not limited by this disclosure, and may generally be any device that captures images, detects eye gaze of occupants of a vehicle, captures other psychographic features, and/or the like and transmit the obtained gaze data to the electronic control unit 120. Any suitable commercially available gaze sensor 117 may be used without departing from the scope of the present disclosure. Psychographic features may include any indication of the individual's personality, values, opinions, attitudes, aspirations, interests, and lifestyles such as past history. That is, psychographic features may explain why an individual does certain things, has certain feelings, enjoys certain foods, routines, and the like. Psychographic information may be determined based on how the individual is dressed, how the individual acts, whether the individual is carrying any objects, the individual's transportation, and/or the like.

In some embodiments, as described in greater detail herein, the gaze sensor 117 may be a sensor that incorporates one or more image sensors, one or more image processors, one or more optical elements, and/or the like. The gaze sensor 117 may generally be used to sense the movement or gaze of the eyes and/or pupils of each occupant within the vehicle and/or psychographic features of each occupant within the vehicle so as to provide feedback during operation. More specifically, the gaze sensor 117 may transmit a plurality of outputs, either wired or wirelessly, to the electronic control unit 120, as explained in greater detail herein. For example, a driver may move his or her gaze left or right as he or she drives to look at different advertisements positioned outside of the vehicle 110 and the advertising system 100 may track a direction of the driver's gaze using, for example, the gaze sensor 117.

The gaze sensor 117 may, in some embodiments, be an image capturing device that captures a plurality of images including live or streaming feeds in real time images such that the electronic control unit 120 may analyze the captured image data, similar to the image data as discussed above with respect to the image capturing device 115 and the electronic control unit 120. In other embodiments, the gaze sensor 117 may be a laser-based sensor, a proximity sensor, a level detection sensor, a pressure sensor, any combination thereof, and/or any other type of sensor that one skilled in the art may appreciate.

While FIG. 1 depicts a single gaze sensor 117, it should be understood that any number of gaze sensors may be used without departing from the scope of the present disclosure. For example, the gaze sensor 117 may be a plurality of gaze sensors arranged to capture gazes of each occupant within the vehicle 110 in tandem, such as, for example, to capture a larger field of view than what would be possible with a single gaze sensor 117 or to capture a plurality of different angles of the same field of view. \

The position sensor 119 is not limited by this disclosure, and may generally be any device that is configured to transmit the location of the vehicle 110 and/or receive the position of other objects, such as restaurant locations, store locations, and the like, relative to the vehicle 110. As such, the position sensor 119 may be a global position system (GPS) device that is communicatively coupled to the electronic control unit 120 and is configured such that the location of the vehicle 110 and/or other objects and route data and/or information may be transmitted and received between the vehicle 110, the remote computing device 125 and/or the data repository 130 wirelessly using Wi-Fi, Bluetooth® and the like via the computer network 105. Any suitable commercially available position sensor 119 may be used without departing from the scope of the present disclosure.

The remote computing device 125 may generally be a computing device that is positioned at a location that may be remote to the electronic control unit 120 and the vehicle 110. As such, the remote computing device 125 may be a mobile electronic device such as a smart phone, laptop, tablet, and the like. The remote computing device 125 may interface with the electronic control unit 120 over the computer network 105 via any wired or wireless connection now known or later developed, such as the various wired or wireless connections described herein. In addition to transmitting and receiving data from the electronic control unit 120, the remote computing device 125 may further interface with the data repository 130 coupled thereto.

While FIG. 1 depicts a single electronic control unit 120 and a single remote computing device 125, it should be understood that each computing device may embody a plurality of computing devices without departing from the scope of the present disclosure. For example, the electronic control unit 120 may receive data from a plurality of remote computing devices 125, such as a remote computing devices 125 for each individual positioned within the vehicle 110.

The data repository 130 may generally be a data storage device, such as a data server, a cloud-based sever, a physical storage device, a removable media storage device, or the like. The data repository 130 may be integrated with the remote computing device 125 and/or the electronic control unit 120 (e.g., a component of the remote computing device 125 and/or the electronic control unit 120) or may be a standalone unit. In addition, while FIG. 1 depicts a single data repository 130, it should be understood that a plurality of data repositories may be used without departing from the scope of the present disclosure. The data repository 130 may generally receive data from one or more sources, such as the remote computing device 125, and store the data. In addition, the data repository 130 may selectively provide access to the data and/or transmit the data, such as to the electronic control unit 120. Illustrative data that may be stored in the data repository 130 may include image data of the advertisement medium, data relating to a calendar of the individual, data related to the current location of the vehicle 110, data related to the current navigation and/or route information, data related to future route information, data relating to psychographic features of an individual, targeted advertisement data, and/or the like, as described in greater detail herein. Further, in some embodiments, the data repository 130 may include advertisement data, such as data provided by advertisers that can be displayed as an advertisement at the vehicle 110, location of the advertisement data, and the like.

Any of the computing devices shown in FIG. 1 may include one or more hardware components thereof. For example, the electronic control unit 120 may contain one or more hardware components that allow the electronic control unit 120 to receive image data from the image capturing device 115, process the image data to determine whether the image data contains engaged advertisement data, determine whether individuals present in the vehicle are engaged with advertisement data via an eye gaze determination based on the length of time looking at the advertisement data, multiple looks at the advertisement data, and/or psychographic features and the like, and display targeted advertising and/or provide information to the individuals positioned within the vehicle, as discussed in greater detail herein. In another example, the remote computing device 125 may contain one or more hardware components that allow the remote computing device 125 to receive data from the electronic control unit 120, process the data, and direct the data repository 130 to access and/or store data.

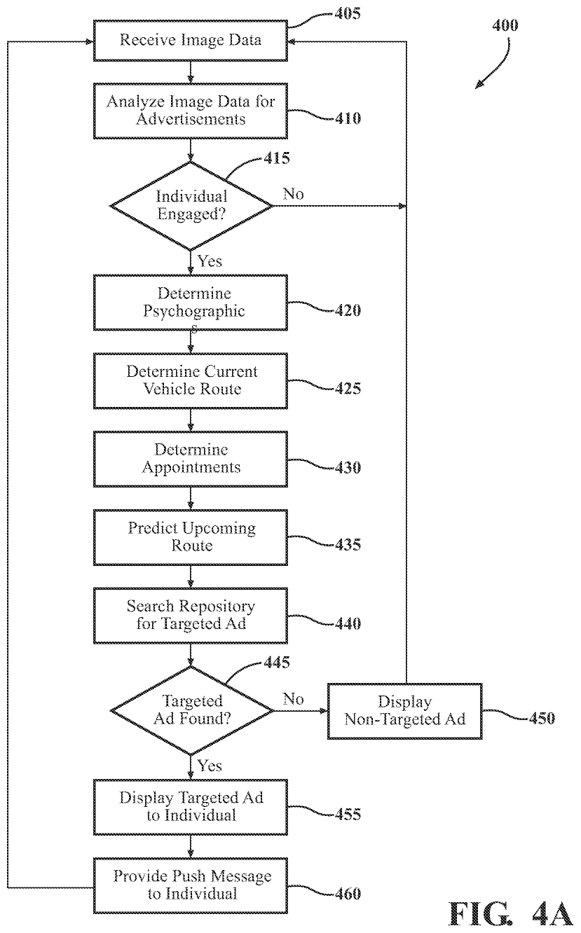

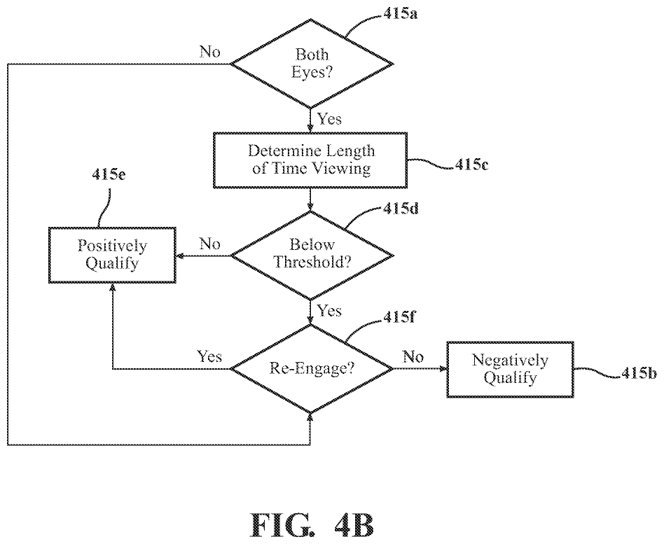

Illustrative hardware components of the electronic control unit 120 and the remote computing device 125 are depicted in FIG. 2. A bus 200 may interconnect the various components. A processing device 205, such as a computer processing unit (CPU), may be the central processing unit of the computing device, performing calculations and logic operations required to execute a program. The processing device 205, alone or in conjunction with one or more of the other elements disclosed in FIG. 2, is an illustrative processing device, computing device, processor, or combination thereof, as such terms are used within this disclosure. Memory, such as read only memory (ROM) 215 and random access memory (RAM) 210, may constitute illustrative memory devices (i.e., non-transitory processor-readable storage media). Such memory 210, 215 may include one or more programming instructions thereon that, when executed by the processing device 205, cause the processing device 205 to complete various processes, such as the processes described herein with respect to FIGS. 4A-4B. In some embodiments, the program instructions may be stored on a tangible computer-readable medium such as a compact disc, a digital disk, flash memory, a memory card, a USB drive, an optical disc storage medium, such as a Blu-ray™ disc, and/or other non-transitory processor-readable storage media.

A storage device 250, which may generally be a storage medium that is separate from the RAM 210 and the ROM 215, may contain a repository 255 for storing the various data described herein. For example, the repository 255 may be the data repository 130 that is integrated with the remote computing device 125 (FIG. 1), as described herein. The storage device 250 may be any physical storage medium, including, but not limited to, a hard disk drive (HDD), memory, removable storage, and/or the like. While the storage device 250 is depicted as a local device, it should be understood that the storage device 250 may be a remote storage device, such as, for example, a server computing device, cloud based storage, and/or the like.

An optional user interface 220 may permit information from the bus 200 to be displayed on a display 225 portion of the computing device in a particular format, such as, for example, in audio, visual, graphic, or alphanumeric format, and/or on a heads up display or other display within the vehicle 110. Moreover, the user interface 220 may also include one or more inputs 230 that allow for transmission to and receipt of data from input devices such as a keyboard, a mouse, a joystick, a touch screen, a remote control, a pointing device, a video input device, an audio input device, a haptic feedback device, and/or the like. Such a user interface 220 may be used, for example, to allow a user to interact with one of the computing devices depicted in FIG. 1 or any component thereof.

A system interface 235 may generally provide the electronic control unit 120 with an ability to interface with one or more external components, such as, for example, any of the other computing devices, the image capturing device 115 (FIG. 1), the gaze sensor 117 (FIG. 1), the position sensor 119 (FIG. 1) and the like (if the computing device is the electronic control unit 120), and/or the data repository 130 (if the computing device is the remote computing device 125). Further, the system interface 235 may communicate between other vehicles, such as V2V communications. Communication with external components may occur using various communication ports (not shown), such as, for example, an Ethernet port, a universal serial bus (USB) port, a wireless networking port, and/or the like. An illustrative communication port may be attached to a communications network, such as the Internet, an intranet, a local network, a direct connection, and/or the like, such as, for example, the computer network 105 (FIG. 1).

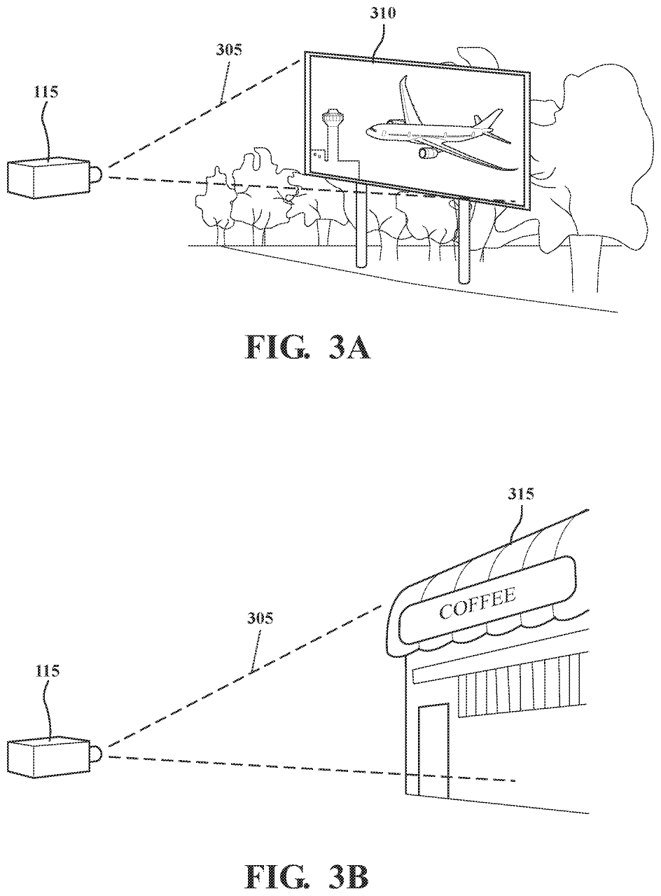

Referring to FIGS. 3A-3B, a field of view 305 of the image capturing device 115 is depicted. The field of view 305 refers to what the image capturing device 115 “sees” when it is obtaining image data. Thus, as shown in FIGS. 3A-3B, the field of view 305 is bounded by the dashed lines; objects located between the dashed lines are within the field of view 305, whereas objects located outside the area bounded by the dashed lines are not within the field of view 305. The field of view 305 may generally be shaped and sized based on various components contained within the image capturing device 115. For example, the field of view 305 may be dependent on the size of one or more image sensor portions of the image capturing device 115, a range of focal lengths of one or more lenses coupled to the imaging device 115, and/or the like. The shape and size of the field of view 305 is not limited by this disclosure, and may generally be any shapes and/or sizes now known or later developed.

In some embodiments, the field of view 305 may be a fixed field of view where the image capturing device 115 captures images from a fixed area. In some embodiments, the field of view 305 may be a moving field of view, where movement of the image capturing device 115 allows it to capture images from a plurality of different areas. In some embodiments, the field of view 305 may be a panoramic or 360° field of view, where the image capturing device 115 contains one or more components that allow it to rotate or otherwise capture a full panoramic or 360° image. In some embodiments, the field of view 305 may be the result of a plurality of image capturing device 115 capturing an image in tandem. In such embodiments, the field of view 305 may be stitched together from the respective individual fields of view of each of the plurality of image capturing device 115.

As illustrated in FIG. 3A. the field of view of the image capturing device 115 is focused on an advertising medium 310, depicted as a billboard. It should be appreciated that the advertising medium 310 is not limited to a billboard and may be any advertising, as discussed in greater detail herein. Further, as illustrated in FIG. 3B. the field of view of the image capturing device 115 is focused on an advertising medium 315, depicted as a storefront with a sign that displays “coffee”. As such, the advertisement data is not limited to merely billboards, but may also include advertisement data that includes signage on storefronts, signage at a road for a particular establishment, and the like.

FIG. 4A depicts an illustrative method 400 of providing targeted advertising according on one or more embodiments. In some embodiments, the method described with respect to FIG. 4A may be completed by the electronic control unit 120 and/or the remote computing device 125, as depicted and described herein with respect to FIG. 1. For the purposes of brevity, the various components completing the illustrative blocks of FIG. 4A may be referred to as “the system” except where specifically described otherwise. Further, it should be appreciated that the steps in FIG. 4A may be completed in any order and may omit some steps and/or include others.

At block 405, the system may receive image data. For example, the image capturing device may be directed to obtain images within its field of view and transmit corresponding image data to the processing device for analysis. As such, the image data may be received from the one or more image capturing devices coupled to the electronic control unit 120. As previously described herein, the image data may contain information regarding one or more images captured by the one or more image capturing devices. For example, the image data may contain one or more images of a field of view of each image capturing device at particular time intervals that include advertisement data. In another example, the image data may contain a plurality of images in the form of a video clip captured by each image capturing device. In some embodiments, the image data may contain information regarding one or more advertisement data.

At block 410, the system may analyze the image data for the presence of advertisement data and determine whether an individual or occupant within the vehicle is engaged with the advertisement, at block 415. For example, the processing device may analyze the image data to determine whether the image capturing device has captured an advertisement data within its field of view. In some embodiments, the system may analyze video at a particular frame rate, in particular intervals, at particular time stamps, or the like. Determining whether an advertisement is detected may include discerning between advertisement and other objects, such as, for example, inanimate objects present within the image data, animals, and/or the like. Discerning between advertisements and other objects may include determining whether certain features generally associated with advertisements are present, such as, for example, symbols, letters, words, phone numbers, pictures, and/or the like. It should be generally recognized that other ways of discerning between advertisements and other objects are included without departing from the scope of the present disclosure. In some embodiments, the system may use any commercially available profile recognition software to discern between advertisements and other objects.

Further, determining an engagement of an individual or others within the vehicle may be completed by the electronic control unit that is coupled to the gaze sensor 117 such that data captured by the gaze sensor 117 is transmitted to the electronic control unit 120. The engagement of an individual or others within the vehicle may be determined based on whether the individual is looking at the advertisement for a particular period of time and/or if the individual is exhibiting certain body language indicative of engagement. Determining whether an individual is engaged may include analyzing the data output by the gaze sensor to determine an orientation of each individual's head, an individual's gaze, an individual's expression, an individual's body movement, and/or the like.

For example, as shown in FIG. 4B, the system may determine whether both of the individual's eyes are visible in the data provided by the gaze sensor as looking at the advertisement, in block 415a. Presence of both of the eyes may be indicative that the individual is focus on the advertisement. In contrast, presence of neither eye or only one eye changes or is gazing towards the advertisement, this may be indicative that the individual is not as focused and not engaged with the advertisement. If both of the individual's eyes are not gazing towards the advertisement, and the individual does not reengage with the advertisement, at block 415f, the system may negatively qualify the advertisement in block 415b and determine the individual is not engaged or not interested in the product that is contained within the advertisement.

If both of the individual's eyes are gazing or focused on the advertisement, the system may determine the length of time the individual is facing the advertisement, at block 415c. In some embodiments, an advertisement may be negatively qualified if the duration of engagement is less than a threshold time, at block 415d and the individual does not reengage with the advertisement, at block 415f. Thus, as shown at block 415d, the system may determine whether the length of time is below the threshold. The threshold time is not limited by this disclosure, and may generally include any time. In some embodiments, the threshold time may be about 1 second. In some embodiments, the threshold time may be more or less than 1 second.

If the length of time is greater than the threshold, the advertisement may be positively qualified, at block 415e, as a result of the individual being engaged with the product or advertisement data. If the length of time is less than the threshold, the system may determine whether the individual becomes reengaged, at block 415f. An individual may become reengaged if he or she views the advertisement again within a certain time period. For example, if the individual becomes distracted and momentarily glances away from the advertisement, but then returns to viewing the advertisement within a certain time period, the individual may be determined to be reengaged. The time period is not limited by this disclosure, and may be any time. For example, in some embodiments, the time period may be about 30 seconds to about 10 minutes, including about 30 seconds, about 1 minute, about 2 minutes, about 3 minutes, about 4 minutes, about 5 minutes, about 6 minutes, about 7 minutes, about 8 minutes, about 9 minutes, about 10 minutes, or any value or range between any two of these values (including endpoints). Further, the individual may reengage with the advertisement at block 415f based on the number of times the individual looks away from the advertisement and returns to look at the advertisement. As such, time is not a factor but the amount of looks or glances is considered by the system. For example, if the individual looks at the advertisement for 3 seconds but looks four different times in a given time period, the individual may be determined to have reengaged, at block 415f.

Further, in some embodiments, determining whether an individual is engaged may be by a history of individual (i.e., the individual has looked at coffee shops along this route several times in the past, the individual has gazed at a “coming soon” sign in the past, a brand preference, an intentionally looking at all coffee shops along a route that may be busy, and/or the like).

If the individual becomes reengaged within the time period, the advertisement may be positively qualified in block 415e. If the individual does not become reengaged within the time period, the advertisement may be negatively qualified at block 415b.

If no advertisement has been detected and/or the individual is not engaged with the determined advertisement data, the method 400 may return to block 405 to receive new image data.

If the individual has been detected as being engaged, the process may proceed optionally to block 420 or to block 425. At block 420, certain psychographic features of the engaged individual may be determined. For example, the system may determine various features from an individual (e.g., facial features) and accessing a database to obtain information associated with such features. For example, if an individual has a particular smile, a database may contain information that might associate that smile to a desired emotion such as interest in a particular advertisement. Psychographic features may include any indication of the individual's personality, values, opinions, attitudes, aspirations, interests, and lifestyles. Psychographic information may be determined based on how the individual is dressed, how the individual acts, facial movements and/or features, whether the individual is carrying any objects, the individual's transportation, and/or the like. For example, if the individual appears to be upset, which may be determined based on known facial characteristics indicative of sadness, such an emotion of sadness may be recorded and determined whether the emotion is due to an advertisement or due to a long line at a favorite coffee shop of the individual. Other psychographic information not specifically described herein may also be determined without departing from the scope of the present disclosure.

At block 425, the current vehicle route is determined. This includes determining the position of the vehicle via the position sensor and/or using current navigation information. The current navigation information may be navigation input by the driver into a vehicle navigation unit and/or may be determined based on determining appointment for the individual, at block 430. The appointment determination may be via a plurality of appointment data retrieved from the remote computing device. That is, individuals may store appointment and other calendar data on the remote computing device, which is accessed by the vehicle and more specifically, by the electronic control unit via the computer network, to determine the upcoming coming appointments and the current route associated with the vehicle to make it to the appointments on time. As such, the system may determine future calendar appoints by analyzing future calendar data, current appoints by analyzing a current calendar data, and the like. In some embodiments, access between the electronic control unit and the remote computing device may be via a software application installed onto the remote computing device.

At block 435, a predicted upcoming or future route is determined based on the current calendar data, future calendar data, and/or the current route information for the vehicle. It should be understood that the predicted upcoming or future route may also be a modification of the current route of the vehicle based on the allotted time available under the current calendar data and/or the future calendar data.

As such, the system, at block 440, searches the repository for a targeted ad, at block 440. The targeted ads meet the individual's engagement and is along the predicted upcoming route, a modified current route, and/or the current route of the vehicle. For example, if the individual has been looking at every coffee shop along the current route and, because of the number of customers already in line, the system has determined that the individual meets the criterial for eye gazing at the advertisement medium and/or for engagement and psychographic information for sadness, the system may send a targeted ad for a coffee shop that is along the predicted upcoming route, a modified route, and/or further along the current route based on and that, based on the allotted time available under the current calendar data and/or the future calendar data, the individual has time to stop. It should be appreciated that the predicted upcoming route and/or the modified route and targeted ad may not be on the most direct route for the individual to drive to the appointment, but fits the required time constraints needed to make the appointment on time. That is, the system may determine a coffee shop along that predicted route and/or modify the route to accommodate for the location of the coffee shop and provide enough time to make it to the appointment on time.

Further, traffic and other variables, such as how busy the coffee shop along the predicted upcoming route or modified route is for the targeted ad may be determined by GPS and other live traffic software, by V2V (vehicle-to-vehicle) communications, and the like.

The targeted ad may be determined by classifying the gaze time, reengagement, and/or psychographic features of the engaged individual to a particular classification, and the particular classification has particular advertisements linked to it, a determination may be made that a targeted ad that fits the engaged individual has been found. For example, if the advertisement data associated with the individual indicate that the individual is likely to be interested in a particular topic (e.g., fast food), the repository may be searched for ads relating to that particular topic (e.g., nearest McDonalds®, Burger King®, Wendys® and the like) along that predicted route and/or the modified route to accommodate for the location of the restaurant and provide enough time to make it to the appointment on time. If the advertisement data associated with the engaged individual cannot be linked to particular advertisements along the current route, predicted upcoming route, and/or modified route, a determination may be made that a targeted ad has not been found at block 445.

In some embodiments, if no targeted ad is found, a non-targeted ad may be displayed, at block 450 and the process may return to block 405 to receive new image data. That is, an advertisement may be displayed to the individual that may or may not match the individual's interests. For example, a most common or most popular ad may be displayed to the individual. In other embodiments, if no target ad is found, no ad may be displayed. That is, instead of displaying a non-targeted ad, the process may bypass block 450 and return to block 405 to receive new image data.

If a targeted ad is found, the targeted ad may be provided to the individual at block 455. The targeted ad may be displayed, for example, via the display within the vehicle. The targeted ad may contain pictographic representation of the targeted ad to the individual, a video representation of the targeted ad to the individual, and/or the like. In some embodiments, the targeted ad may be specifically customized to the individual. For example, the targeted ad may display the individual's name or other information to indicate to the individual that the targeted ad is intended for him/her. In some embodiments, a push message may be provided to the individual, at block 460. The push message may be delivered electronically or manually to the remote computing device of the individual. The push message may be pushed to the individual's mobile device via any technology now known or later developed. For example, the message may be pushed via an NFC transmission, an RFID tag, a Bluetooth connection, and/or the like. In another example, the message may be pushed via a service such as Apple® iBeacon®, beacons transmitted via Google® Eddystone™, and/or the like. The message may be additional advertising, a coupon, a URL to a website, and/or the like. It should be appreciated that the push message may be advantageous for individuals within the vehicle but do not have a direct line of sight with the display of the vehicle. For example, an individual positioned within a third row within a van may not have a direct view of the display within the vehicle. In some embodiments, providing the push message to the individual, at block 460 is omitted and the target ad is only displayed via the display of the vehicle.

It should now be understood that the devices and methods described herein capture image data of an advertisement, determine whether individuals present in the vehicle are engaged with advertisement data via an eye gaze determination based on the length of time looking at the advertisement data, multiple looks at the advertisement data, and/or psychographic features of a potential engaged individual, and the like, and display targeted advertising to the occupants of the vehicle based on the current route of the vehicle, a predicted upcoming route and/or a modified route, each of which correspond to known appointments and calendar events of the individuals positioned within the vehicle, as discussed in greater detail herein.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An advertising system comprising:
a vehicle including:
one or more imaging devices coupled to the vehicle and that obtain an image data, wherein the image data contains an advertisement data captured from an environment external to the vehicle;
one or more gaze sensors coupled to the vehicle and that obtain a gaze data, wherein the gaze data contains data as to whether one or more individuals within the vehicle have viewed the advertisement data; and
an electronic control unit that:
analyzes the image data to determine the advertisement data,
determines that at least one individual of the one or more individuals are engaged with the advertisement data following the analysis of the image data,
determines a current route of the vehicle based on a current route data,
obtains a calendar of the at least one individual of the one or more individuals, and
provides a targeted ad to the at least one individual of the one or more individuals based on the engagement of the at least one individual of the one or more individuals with the advertisement data, the current route of the vehicle and an allotted time based on the calendar of the one or more individuals.

2. The advertising system of claim 1, wherein the electronic control unit is further configured to:
determine a future calendar event based on a future calendar data;
determine a location of the future calendar event and a location of the targeted ad;
predict a future route for the vehicle based on a future route data; and
provide the targeted ad to the at least one individual of the one or more individuals based on the predicted future route of the vehicle and the allotted time based on the future calendar event of the calendar of the one or more individuals based on the current route.

3. The advertising system of claim 2, wherein the electronic control unit is further configured to:
determine the future calendar event based on the future calendar data;
determine the location of the future calendar event and the location of the targeted ad;
modify the current route or the predicted future route for the vehicle; and
provide the targeted ad to the at least one individual of the one or more individuals based on the modified current route of the vehicle and the allotted time based on the future calendar event of the calendar of the one or more individuals based on the current route.

4. The advertising system of claim 1, wherein:
the electronic control unit determines that the at least one individual of the one or more individuals are engaged with the advertisement data via a determination of one or more psychographic features of the at least one individual.

5. The advertising system of claim 1, wherein:
the electronic control unit determines that the at least one individual of the one or more individuals are engaged with the advertisement data when:
a gaze determination exceeds a predetermined amount of time threshold that the at least one individual has gazed at the advertisement data; or
a gaze determination determines a reengagement of the at least one individual by exceeding a predetermined number of times that a gaze of the at least one individual returns to the advertisement data.

6. The advertising system of claim 5, wherein the electronic control unit provides a non-targeted ad to the at least one individual of the one or more individuals when:
the gaze determination is less than the predetermined amount of time threshold that the at least one individual has gazed at the advertisement data; or
the at least one individual does not reengage the advertisement data by the predetermined number of times.

7. The advertising system of claim 3, wherein the electronic control unit provides a non-targeted ad to the at least one individual of the one or more individuals when no targeted ad corresponds to the at least one of:
the current route of the vehicle;
the modified current route of the vehicle;
the predicted future route of the vehicle; and
the allotted time based on the future calendar event of the calendar of the one or more individuals based on the current route, the modified current route and the predicted future route.

8. The advertising system of claim 1, wherein the advertisement data captured from the environment external to the vehicle includes at least one of:
a billboard,
a storefront,
a sign,
a poster
a name of a business, and
a graphic.

9. The advertising system of claim 1, further comprising a remote computing device communicatively coupled to the electronic control unit via a computer network.

10. The advertising system of claim 1, further comprising a data repository coupled to the electronic control unit via a computer network.

11. The advertising system of claim 10, wherein the data repository stores at least one of:
the image data;
the advertisement data;
the current route data of the vehicle;
the calendar of the at least one individual;
a future calendar data of the at least one individual;
a future route data of the vehicle; and
a location of the targeted ad.
